(19) United States
(12) Patent Application Publication
(10) Pub. No.: US 2026/0287931 A1
(43) Pub. Date: Sep. 24, 2026

(54) CONTACT LENS BALLASTING

(71) Applicant: CooperVision International Limited, Fareham (GB)

(72) Inventor: Martin WEBBER, Eastleigh (GB)

(73) Assignee: CooperVision International Limited, Fareham (GB)

(21) Appl. No.: 19/567,343

(22) Filed: Mar. 16, 2026

(30) Foreign Application Priority Data
Mar. 19, 2025 (GB) 2503995.9

(51) Int. Cl. G02C 7/04

(52) U.S. Cl. CPC G02C 7/048

(57) ABSTRACT

A ballasted contact lens 1 is disclosed. In a first quadrant 24 defined between the horizontal and vertical meridians 18, 20 the thickness t of the lens body 3 varies with angular position around the centre of the optic zone 6; the thickness of the lens body 3 increases monotonically with distance from the peripheral edge 16 inwardly along a first blink axis 22; and the maximum thickness of the lens body 3 at any given radial position lies within 5 degrees or 5% of the angle of the first blink axis 22 to the vertical meridian 18. The first blink axis 22 is a straight line inclined at an angle from the vertical meridian 18, said angle having a magnitude in the range of from 5 degrees to 50 degrees inclusive. A method of stabilizing a contact lens on an eye is also disclosed.

### FIELD

This application claims priority to United Kingdom Patent Application No. 2503995.9, filed Mar. 19, 2025, which is incorporated in its entirety by reference herein.

The present disclosure relates especially, but not exclusively to contact lenses, more particularly, but not exclusively, contact lenses having a thickness profile that ballasts the lens. The present disclosure also relates especially, but not exclusively to a method of stabilizing a contact lens on an eye.

### BACKGROUND

For some applications, the orientation of a contact lens on the eye is important in order to achieve the desired effect. For example, toric lenses are used in the correction of astigmatism. Typically, a toric lens has different optical powers in two perpendicular orientations known as the steep and flat axes. The steep axis provides the higher optical power. Together, the front and rear surfaces of the lens provide a spherical power, which may be used in the correction of myopia, hyperopia and/or presbyopia. A surface (typically, the rear surface) of the lens is also shaped to provide the difference in power along the flat and steep axes, that difference being referred to as the cylinder power. The steep and flat axis of a toric contact lens need to be correctly orientated with respect to the eye in order to correct vision. Cosmetic contact lenses may also need to be maintained in a particular orientation on the eye in order to achieve the desired effect. For example, a cat's eye lens would typically be worn with the long axis of the oval pupil vertical.

One approach to maintaining a contact lens in the correct orientation is to truncate the contact lens at its lower edge, so that the lens rests on the lower eyelid. In some examples, the upper edge is also truncated, so that the upper eyelid rests on the truncated edge. However, truncated lenses may be less comfortable for a user.

Another approach is to incorporate a ballast into the lens that helps to maintain the lens in the correct orientation. For example, “prism” or “wedge” ballasting involves increasing the thickness (and therefore the weight) of the lens in the inferior part of the lens so as to form a base-down prism. Gravity then causes the heavier prism base to locate inferiorly. A peri-ballast is a prism ballast in which the prismatic thickness profile is outside of the optic zone. Increasing the thickness of the lens as in prism ballasting and peri-ballasting may reduce oxygen transmission across the lens.

A further approach is dynamic stabilisation in which pressure from the eyelids (primarily the upper lid) is used to orientate the lens through interaction between the eyelids and the shape of the lens. Typically, the thickness of the lens is reduced at the superior and inferior edges to produce a so-called thickness differential, and the action of the eyelids on these thinner regions serves to stabilize the lens on the eye. The thickness differential that can be achieved at the edge of the lens depends on the spherical power of the lens, with lower-powered lenses having a reduced maximum thickness differential, and therefore potentially reduced stabilization.

WO01/75509A1 (OCULAR SCIENCES, INC.) describes a contact lens in which, in a region outside the optic zone, a ballast portion increases in thickness in a direction along the vertical meridian and has a substantially uniform thickness perpendicular thereto. WO01/75509A1 describes how this may provide more effective interaction between the stabilization mechanism and the eyelid during blinking.

While many of the approaches described above are in widespread use and may provide satisfactory stability, it would be advantageous to provide a contact lens that offers yet further improved stability on the eye.

The present disclosure seeks to mitigate the above-mentioned problems. Alternatively or additionally, the present disclosure seeks to provide improved ballasted contact lenses.

### SUMMARY

According to a first aspect, the present disclosure provides a contact lens comprising:
a contact lens body having a convex anterior surface, a concave posterior surface, and a peripheral edge therebetween,
the contact lens body having a thickness between the anterior surface and the posterior surface,
the contact lens body comprising:
   a peripheral zone adjacent the peripheral edge, the thickness of the body in the peripheral zone tapering towards the peripheral edge;
   an inner zone, circumscribed by the peripheral zone; and
   an optic zone circumscribed by the inner zone;
the thickness of the lens body in the inner zone is non axisymmetric so as to ballast the lens and thereby define a superior edge and an inferior edge of the lens, with a vertical meridian being defined from the superior edge toward the inferior edge, and a horizontal meridian being defined perpendicular thereto;
the inner zone comprises a superior portion, being the portion of the inner zone above the horizontal meridian;
in the superior portion of the inner zone, in a first quadrant defined between the horizontal and vertical meridians, for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens; and
(iii) the maximum thickness of the lens body at any given radial position lies within 5 degrees or 5% of the angle of the first blink axis to the vertical meridian whichever is lesser in absolute terms; and
wherein the first blink axis is a straight line inclined at an angle from the vertical meridian, said angle having a magnitude in the range of from 5 degrees to 50 degrees inclusive.

According to another aspect of the disclosure, there is provided a contact lens comprising:
a contact lens body having a convex anterior surface, a concave posterior surface, and a peripheral edge therebetween,
the contact lens body having a thickness between the anterior surface and the posterior surface
the contact lens body comprising:
   a peripheral zone adjacent the peripheral edge, the thickness of the body in the peripheral zone tapering towards the peripheral edge;
   an inner zone, circumscribed by the peripheral zone; and
   an optic zone circumscribed by the inner zone; and wherein
in a first angular sector of the inner zone spanning at least 10 degrees, the thickness of the lens body increases monotonically along a first blink axis of the lens, and the lens body comprises a series of consecutive cross-sections, each cross-section extending along a first reference axis, each first reference axis extending transversely to the first blink axis, each cross-section having a substantially uniform thickness not varying by more than 15 μm or 10% of the minimum thickness along said first reference axis whichever is greater in absolute terms; and
in a second, different, angular sector of the inner zone spanning at least 10 degrees, the thickness of the lens body increases monotonically along the length of a second, different, blink axis of the lens, and the lens body comprises a series of consecutive cross-sections, each cross-section extending along a second reference axis, each second reference axis extending transversely to the second blink axis, each cross-section having a substantially uniform thickness not varying by more than 15 μm or 10% of the minimum thickness along said reference axis whichever is greater in absolute terms.

According to another aspect of the disclosure, there is provided a contact lens comprising:
a contact lens body having a convex anterior surface, a concave posterior surface, and a peripheral edge therebetween;
the contact lens body having a thickness between the anterior surface and the posterior surface;
the contact lens body comprising:
   a peripheral zone adjacent the peripheral edge, the thickness of the body in the peripheral zone tapering towards the peripheral edge;
   an inner zone, circumscribed by the peripheral zone; and
   an optic zone circumscribed by the inner zone; and wherein in a 90 degree sector of the inner zone and for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens;
(iii) the maximum thickness of the lens body at any given radial position lies within 5 degrees or 5% of the angle of the first blink axis to the vertical meridian whichever is lesser in absolute terms ; and
(iv) a reference axis extends transversely to the blink axis, and along said reference axis on each side of the blink axis for a distance ending at the blink axis and being equal to at least 5% of the minimum width of the inner zone, the thickness of the lens body monotonically increases with distance along the reference axis towards the blink axis by at least 15 μm or 10% of the minimum thickness along said reference axis whichever is greater in absolute terms.

According to another aspect of the disclosure there is provided a contact lens comprising:
a contact lens body having a convex anterior surface, a concave posterior surface, and a peripheral edge therebetween;
the contact lens body having a thickness between the anterior surface and the posterior surface;
the contact lens body comprising:
   a peripheral zone adjacent the peripheral edge, the thickness of the body in the peripheral zone tapering towards the peripheral edge;
   an inner zone, circumscribed by the peripheral zone; and
   an optic zone circumscribed by the inner zone; and wherein in a 90 degree sector of the inner zone and for the majority of the minimum width of the inner zone:
(i) the thickness of the lens body increases monotonically with distance from the peripheral edge radially inwardly; and
(ii) the thickness of the lens body at any given radial position varies with angular position around the centre of the optic zone by at least 15 μm or 10% of the minimum thickness in the inner zone whichever is greater in absolute terms, thereby forming a ridge that extends radially across the majority of the minimum width of the inner zone.

According to another aspect of the disclosure there is provided a method of stabilizing a contact lens on an eye, the contact lens comprising
a contact lens body having an anterior surface positioned adjacent the eye, a concave posterior surface on the opposite side of the lens body to the anterior surface, and a peripheral edge therebetween, and a thickness between the anterior surface and the posterior surface;
wherein the method comprises, while the contact lens is on the eye, the interaction of the lens body and one or more eyelids of the eye generating a force that acts to maintain the lens in a predetermined orientation on the eye, and wherein in said predetermined orientation:
the contact lens body comprises:
   a vertical meridian and a horizontal meridian;
   an optic zone positioned over the pupil of the eye;
   an inner zone circumscribing the optic zone;
   a first quadrant defined between the horizontal and vertical meridians in a superior portion of the inner zone;
and wherein in said first quadrant, for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens, said first blink axis being inclined at an angle (a) having a magnitude of 5 degrees or less to the direction of motion of an upper eyelid of the eye during closing and/or (b) having a magnitude in the range of from 5 degrees to 50 degrees inclusive from the vertical meridian; and
   (iii) the maximum thickness of the lens body at any given radial position lies within 5 degrees or 5% of the angle of the first blink axis to the vertical meridian whichever is lesser in absolute terms.

Optional but preferred features are set out herein.

It will of course be appreciated that features described in relation to one aspect of the present disclosure may be incorporated into other aspects of the present disclosure. For example, the method of the disclosure may incorporate any of the features described with reference to the apparatus of the disclosure and vice versa.

### BRIEF DESCRIPTION OF THE DRAWINGS

Embodiments of the present disclosure will now be described by way of example only with reference to the accompanying schematic drawings, of which:

FIG. 1A shows a plan view of the anterior surface of a contact lens suitable for use in an example embodiment;

FIG. 1B shows a plan view of the posterior surface of the contact lens of FIG. 1A;

FIG. 1C shows a cross sectional view of the contact lens of FIG. 1B, taken through the optic zone centre;

FIG. 2 shows a plan view of the front surface of the lens of FIGS. 1A-C and shows details of the variation in the thickness t in the inner zone 14 of the lens of FIGS. 1A-C in accordance with a first example embodiment of the disclosure;

FIG. 3 shows a schematic plot of distance inwardly along the blink radius versus thickness t of the lens body in the inner zone for the lens of FIG. 2;

FIG. 4 shows a plan view of part of the front surface 2 of the lens of FIGS. 1A-C and shows details of the variation in the thickness t in the upper-right quadrant 24 of the inner zone 14 of the lens of FIGS. 1A to 1C in accordance with a second example embodiment of the disclosure;

FIG. 5A shows a schematic plot of the variation of the thickness t of the lens body along the reference axis 28 in the inner zone for the lens of FIG. 4;

FIG. 5B shows a schematic plot of distance along the blink radius versus thickness t of the lens body in the inner zone for the lens of FIG. 4;

FIG. 6 shows a contact lens blister package 80 including a contact lens in accordance with example embodiments of the disclosure;

FIG. 7 shows a flow chart of an example method, in accordance with the present disclosure, of stabilizing a contact lens on an eye of a user; and

FIG. 8 shows a flow chart of an example method, in accordance with the present disclosure, of manufacturing a contact lens.

### DETAILED DESCRIPTION

According to a first aspect of the disclosure, there may be provided a contact lens comprising a contact lens body. The contact lens body may comprise a convex anterior surface and a concave posterior surface. The contact lens body may comprise a peripheral edge between (i.e. at the meeting of) the convex anterior surface and a concave posterior surface. The contact lens body has a thickness between the anterior surface and the posterior surface. The contact lens body may comprise a peripheral zone. The peripheral zone may be adjacent the peripheral edge. It may be that the thickness of the body in the peripheral zone tapers towards the peripheral edge. The contact lens body may comprise an inner zone. It may be that the inner zone is circumscribed by the peripheral zone and/or circumscribes the optic zone. The contact lens may comprise an optic zone. It may be that the optic zone is circumscribed by the inner zone. It may be that the contact lens body, for example the thickness of the contact lens body, in the inner zone is configured to ballast the lens. It may be that the thickness of the contact lens body is non axisymmetric in the inner zone. It may be that thickness of the lens body in the inner zone is non axisymmetric so as to ballast the lens. Said ballasting of the lens may thereby define a superior edge and an inferior edge of the lens. A vertical meridian is defined from the superior edge towards the inferior edge. A horizontal meridian is defined perpendicular to the vertical meridian. The inner zone may comprise a superior portion, being the portion of the inner zone above the horizontal meridian. A quadrant (a first quadrant) may be defined in the superior portion of the inner zone, between the horizontal and vertical meridians. It may be that in said first quadrant and/or for the majority of (for example the whole of) the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a blink axis of the lens; and/or
(iii) the maximum thickness of the lens body at any given radial position lies on the blink axis and/or the maximum thickness of the lens body at any given radial position lies within 5 degrees or 5% of the angle of the first blink axis to the vertical meridian whichever is lesser in absolute terms.

Thus, the increase in thickness that ballasts the lens in said first quadrant may occur along or close to the blink axis. The applicants have identified that during blinking the edges of the eyelids do not remain horizontal. Instead, the upper eyelid moves downward and nasally (i.e. towards the nose) as the eyelids close. Without wishing to be bound by theory it is believed that having the thickness of the lens body increasing along an axis that is closer to and/or aligned with the direction of movement of the eyelid when closing results in the interaction between the eyelids and the lens generating greater forces and/or forces that are more effective at reliably stabilising the lens on the eye than prior art lenses. This may reduce movement of the lens on the eye thereby improving vision and/or allow for a comparable degree of stability of the lens to be achieved with less thickening of the lens thereby providing improved oxygen transmissibility. Additionally or alternatively, increasing the thickness of the lens body along an axis that is better aligned with the direction of movement of the eyelid may provide a lens that is more comfortable for a user. Additionally or alternatively increasing the thickness of the lens body along an axis that is better aligned with the direction of movement of eyelid may result in the region of maximum thickness in the inner zone being adjacent the optic zone, and thereby facilitate the integration of ballast into lower-powered lenses.

It will be appreciated that the or each blink axis of the lens is a (notional) straight line. It may be that the blink axis extends through the intersection of the vertical and horizontal meridians (i.e. the blink axis is a blink radius). It may be that the blink axis extends through the geometric centre of the lens.

The blink axis may be inclined at an angle to the vertical meridian. Said angle may have a magnitude in the range of from 5 degrees to 50 degrees inclusive to the vertical meridian (i.e. an angle of from 5 degrees to 50 degrees in either direction from the vertical). For example, the blink axis may be inclined at an angle having a magnitude in the range of from 5 degrees to 35 degrees inclusive from the vertical meridian, for example of from 7 degrees to 35 degrees inclusive from the vertical meridian. Analysis of video and images from 5 different individuals showed the magnitude of the angle at which the upper eyelid moved relative to the vertical axis to be in the range of from 10.3 degrees to 27.3 degrees during closure of the right eye, and from 8.8 degrees and 31.3 degrees during closure of the left eye. Said analysis showed the magnitude of the angle at which the upper eyelid moved relative to the vertical axis to be in the range of from 12.4 degrees to 27.8 degrees during opening of the right eye, and from 11.4 degrees and 29.3 degrees during opening of the left eye. These angles were determined by marking a dot on the upper eyelid, said dot being aligned with a vertical line through the pupil centre and being visible when the upper eyelid is open. The movement of the eyelid is recorded and the change in x (horizontal movement) and change in y (vertical movement) between the eyelid being fully open and fully closed was obtained from said recording. The angle was calculated by combining the x and y components of the movement. It will be appreciated that the blink axis of the lens need not be precisely aligned with the direction of movement of an individual's eyelid in order to obtain some benefit over prior art lenses in which thickness increases along the vertical meridian.

The thickness of the body may be defined as the distance between the anterior and posterior surface of the body at any given position when measured perpendicular to the posterior surface.

As used herein, “ballast the lens” refers to a variation in the thickness of the lens body that is configured to maintain the lens in a predetermined orientation on the eye. Said ballasting may comprise prism balancing, peri-ballasting, dynamic stabilisation or any other type of ballasting based on a variation in the thickness of the lens. The variation in the thickness of the lens may be referred to herein as a thickness profile.

In said predetermined orientation on the eye, the superior edge of the lens is a portion of the peripheral edge that is uppermost (in the vertical sense), and an inferior edge of the lens is a portion of the peripheral edge that is lowermost (in the vertical sense). In said predetermined orientation on the eye, the vertical meridian is the meridian that is vertical and the horizontal meridian is the meridian that is horizontal.

As used herein “monotonically” in reference to increasing thickness may be understood as meaning the thickness is always increasing or remaining constant.

Each of the inner zone and the peripheral zone extends around the whole of the zone it circumscribes.

As used herein “the maximum thickness of the lens body at any given radial position lies within 5 degrees or 5% of the angle of the blink axis to the vertical meridian whichever is lesser in absolute terms” may be understood as meaning that the maximum thickness lies within X degrees either side of the blink axis, wherein X is the smaller in magnitude of 5 or 0.05 times the magnitude of the angle of the blink axis to the vertical meridian.

The inner zone has a width being the extent of the zone in a radial direction from the optic zone centre. For example, the inner zone may be defined as the radial distance between the outer edge of the optic zone and the inner edge of the peripheral zone. The minimum width of the inner zone may be defined as the minimum radial extent of the inner zone around the optic zone. For example, the minimum width may be the minimum radial distance between the outer edge of the optic zone and the inner edge of the peripheral zone around the optic zone. Typically, a border can be visibly discerned at the junction of the inner zone and the peripheral zone

As used herein, the term “contact lens” refers to an ophthalmic lens that can be placed onto the anterior surface of the eye. It will be appreciated that such a contact lens will provide clinically acceptable on-eye movement and not bind to the eye or eyes of a person. The contact lens may be a corneal lens (e.g. a lens that rests on the cornea of the eye), or a scleral lens (e.g. a lens that rests on the sclera of the eye). The contact lens may be a soft contact lens, such as a hydrogel contact lens or a silicone hydrogel contact lens. The contact lens may be a rigid gas permeable contact lens.

The optic zone encompasses parts of the lens that have optical functionality. The optic zone is configured to be positioned over the pupil of an eye when in use. It may be that the geometric centre of the lens is located within the optic zone. The vertical meridian and the horizontal meridian may intersect at the geometric centre of the lens and/or the optic zone centre.

The optic zone may be a toric optic zone, having a steep and a flat axis. The optic zone centre may be defined as the point at which the steep and flat axis intersect. The centre of the optic zone (the optic zone centre) may be located at the geometric centre of the lens. Alternatively, the optic zone centre may be spaced apart from the geometric centre of the lens.

The minimum width of the peripheral zone may be very much less than the minimum width of the inner zone. For example, the minimum width of the peripheral zone may be 10 percent or less than the minimum width of the inner zone. It may be that the thickness of the lens body is axisymmetric across the majority of, for example the whole of, the width of the peripheral zone. The peripheral zone has a width being the extent of the zone in a radial direction from the optic zone centre. For example, the peripheral zone may be defined as the radial distance between the outer edge of the inner zone and the peripheral edge of the lens. The minimum width of the peripheral zone may be defined as the minimum radial extent of the peripheral zone around the optic zone. For example, the minimum width may be the minimum radial distance between the outer edge of the inner zone and the peripheral edge of the lens around the optic zone.

The contact lens body may have a base curvature, for example a spherical base curvature. The base curvature may be the curvature of the posterior surface of the lens body. It may be that in the inner zone, the lens body has a spherical base curvature (i.e. a spherical posterior surface). It may be that in the inner zone, the lens body has an axisymmetric posterior surface. It may be that in the inner zone, the shape of the anterior surface varies so as to ballast the lens. It may be that in the inner zone, the shape of the anterior surface varies so as to provide a lens body having a thickness as described herein. It may be that in the inner zone, the anterior surface is non-axisymmetric.

It may be that the thickness of the lens body in the inner zone increases along the or each blink axis from less than or equal to 100 μm to at least 300 μm. For example, the thickness of the lens body in the inner zone may vary along the blink axis in the range of from 60 μm to 320 μm inclusive.

It may be that in said first quadrant, the inner zone comprises a series of consecutive cross-sections extending transversely (e.g. perpendicular) to the blink axis. It may be that each cross-section spans a distance along the blink axis of at least 5% of the minimum width of the inner zone. It may be that in each cross-section the lens body has a substantially uniform thickness not varying by more than 15 μm or 10% of the minimum thickness of said cross-section whichever is greater in absolute terms. Thus, it may be that in said first quadrant the inner zone comprises a series of (notional) strips, each strip being perpendicular to the blink axis and having a substantially constant thickness. Providing the change in thickness as a series of strips may facilitate manufacturing. It may be that each cross-section extends for a distance equal to at least 5% of the minimum width of the inner zone on either side of the blink axis. Providing such a series of cross-sections may facilitate manufacture (e.g. by simplifying tooling) and/or design by providing the required thickness profile in a straightforward matter. Providing such a series of cross-sections may result in a lens that is more stable on the eye and/or acceptably stable for a wider range of eyes (i.e. eyes that have a variation in

It may be that for the majority of, for example the whole of, the minimum width of the inner zone a (first) reference axis extends transversely (e.g. perpendicular) to the (first) blink axis. It may be that, in said first quadrant, along each reference axis and on each side of the blink axis, the thickness of the lens body monotonically increases over a distance along the reference axis towards the blink axis. It may be that said distance ends at the blink axis. It will be appreciated that distance towards (i.e. ending at) the blink axis is distance away from the horizontal or vertical axis, depending on which side of the blink axis is being considered. It may be that the thickness monotonically increases along the reference axis by at least 15 μm or 10% of the minimum thickness along said reference axis whichever is greater in absolute terms. It may be that the thickness monotonically increases for a distance along the reference axis ending at the blink axis, said distance being equal to at least 5% of the minimum width of the inner zone. It may be that the thickness of the lens body in the inner zone increases along the or each reference axis from less than or equal to 100 μm to at least 300 μm. For example, the thickness of the lens body in the inner zone may vary along the reference axis in the range of from 60μm to 320 μm inclusive. For example, for at least one radial distance from the optic zone centre, the thickness of the lens body in the inner zone may vary from less than or equal to 100 μm at the vertical and/or horizontal meridian to at least 300 μm at the blink axis.

Thus, it may be that the maximum thickness for any given radial position in said first quadrant lies within 5 degrees or 5% of the angle of the blink axis to the vertical meridian whichever is lesser in absolute terms. It may be that the maximum thickness for any given radial position in said first quadrant lies within 2 degrees or 1% of the blink axis to the vertical meridian whichever is lesser in absolute terms. It may be that the maximum thickness for any given radial position in said first quadrant lies on the blink axis. It will be appreciated that the thickness of the lens may be substantially constant over a small region on either side of the blink axis. Thus, it may be that the maximum thickness is not only found on the blink axis. It may be that in said first quadrant the thickness of the lens body varies so as to provide a ridge extending radially across the majority, for example the whole of, the minimum width of the inner zone. It may be that the ridge extends along the blink axis for the majority, for example the whole of, the minimum width of the inner zone. It may be that the ridge extends radially from the geometric centre of the lens. It may be that the lens comprises a single ridge in said first quadrant. Without wishing to be bound by theory it is believed that having such a ridge aligned with the blink axis may assist in guiding the lens into position. Additionally or alternatively, reducing the thickness of the lens away from the blink axis may reduce the amount of material used in the lens and thereby provide improved oxygen transmission.

It will be appreciated that the or each reference axis is a (notional) straight line. It may be that when viewed in plan, the or each reference axis is extends transversely (e.g. perpendicular) to the blink axis. The reference axis intersects the blink axis.

A second, different, quadrant may be defined, for example in the superior portion of the inner zone. The second quadrant may be defined between the horizontal and vertical meridians. The second quadrant may be defined on the opposite size of the vertical meridian to the first quadrant. It may be that in said second quadrant and/or for the majority of (for example the whole of) the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a second, different, blink axis of the lens; and/or
(iii) the maximum thickness of the lens body at any given radial position lies on the second blink axis and/or the maximum thickness of the lens body at any given radial position lies within 5 degrees or 5% of the angle of the first blink axis to the vertical meridian whichever is lesser in absolute terms. The second quadrant, second blink axis and/or any of the element of the lens in the second quadrant may be as described above with reference to the first quadrant. For example, the second quadrant may comprise a second series of consecutive cross-sections extending transversely to the second blink axis. It may be that a second reference axis is defined extending transversely to the second blink axis. It may be that the first and second quadrants do not overlap.

It may be that thickness of the lens body in the first and second quadrants is symmetrical about the vertical meridian. This may allow the same lens design to be used for both the left and right eyes.

It may be that the inferior and superior portions of the inner zone are asymmetric about the horizontal meridian. It may be that in the inferior portion the thickness of the lens body at any given radial position varies with angular position around the centre of the optic zone by less than 15 μm or 10% of the minimum thickness in the inner zone whichever is lesser in absolute terms. The thickness of the lens in the inferior portion may so vary for the majority of, for example the whole of, the minimum width of the inner zone. The thickness of the lens in the inferior portion may so vary over an angular sector of at least 45 degrees, for example at least 90 degrees.

It may be that in the inferior portion the inner zone comprises an inferior series of cross-sections, each cross-section of the inferior series being referred to herein as an inferior cross-section. It may be that the inferior portion of the inner zone comprises a series of consecutive inferior cross-sections extending transversely (e.g. perpendicular) to the vertical meridian. It may be that each inferior cross-section spans a distance along the vertical meridian of at least 5% of the minimum width of the inner zone. It may be that in each inferior cross-section the lens body has a substantially uniform thickness not varying by more than 15 μm or 10% whichever is greater in absolute terms.

A contact lens according to the present disclosure may comprise, consist essentially of, or consist of any one of the following: an elastomer material, a silicone elastomer material, a hydrogel material, or a silicone hydrogel material. A contact lens according to the present disclosure may comprise an elastomer material, a silicone elastomer material, a hydrogel material, or a silicone hydrogel material or combinations thereof. As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, and the like.

Alternatively, the contact lens may comprise, consist essentially of, or consist of a silicone elastomer material. For example, the lens may comprise, consist essentially of, or consist of a silicone elastomer material having a Shore A hardness from 3 to 50. The shore A hardness can be determined using conventional methods, as understood by persons of ordinary skill in the art (for example, using a method DIN 53505). Other silicone elastomer materials can be obtained from NuSil Technology or Dow Chemical Company, for example.

The lens may comprise a contact lens having a lens diameter of between 13 and 15 mm. The optic zone of the lens may have a diameter of between 7 and 9 mm. By way of example, the lens may comprise a hydrogel or silicone hydrogel contact lens having a lens diameter of between 13 and 15 mm.

The contact lens may be a molded contact lens. The lens can be formed by cast molding processes, spin cast molding processes, or lathing processes, or a combination thereof. As understood by persons skilled in the art, cast molding refers to the molding of a lens by placing a lens forming material between a female mold member having a concave lens member forming surface, and a male mold member having a convex lens member forming surface.

The contact lens may be a cosmetic contact lens. The contact lens may be lens useful in the correction of myopia, hyperopia and/or presbyopia.

In a second aspect of the disclosure there is provided a contact lens. The contact lens may comprise a contact lens body having a convex anterior surface, a concave posterior surface, and optionally a peripheral edge therebetween. The contact lens body has a thickness between the anterior surface and the posterior surface. The contact lens body may comprise a peripheral zone, for example a peripheral zone adjacent the peripheral edge. It may be that the thickness of the body in the peripheral zone tapering towards the peripheral edge. The contact lens body may comprise an inner zone, for example circumscribed by the peripheral zone. The contact lens body may comprise an optic zone. It may be that the optic zone is circumscribed by the inner zone. It may be that a first angular sector of the inner zone spans at least 10 degrees. It may be that in the first angular sector, the thickness of the lens body increases monotonically along a first blink axis of the lens. It may be that in the first angular sector the lens body comprises a series of consecutive cross-sections. It may be that in the first angular sector each cross-section extends along a first reference axis. It may be that each first reference axis extends transversely (e.g. perpendicular) to the first blink axis. It may be that each cross-section in the first angular sector has a substantially uniform thickness (i.e. a thickness not varying by more than 15 μm or 10% of the minimum thickness along said first reference axis whichever is greater in absolute terms). It may be that a second, different, angular sector of the inner zone spans at least 10 degrees. It may be that in the second angular sector the thickness of the lens body increases monotonically along the length of a second, different, blink axis of the lens. It may be that in the second angular sector the lens body comprises a series of consecutive cross-sections. It may be that in the second angular sector each cross-section extends along a second reference axis. It may be that each second reference axis extends transversely (e.g. perpendicular) to the second blink axis. It may be that each cross-section in the second angular section has a substantially uniform thickness.

Thus, it may be that in two different sectors the inner zone comprises a series of (notional) strips, each strip being extending transversely to the blink axis in that sector and having a substantially constant thickness. It may be that the thickness of said strips increases with distance along the blink axis away from the peripheral edge. The contact lens of the second aspect may have any of the features described above with reference to the first aspect, and vice versa.

An angular sector may be defined as the portion of the inner zone extending circumferentially around a portion of the optic zone. The first angular sector does not overlap with the second angular sector. The first and/or second angular sector may span at least 10 degrees, at least 20 degrees, at least 45 degrees. The first and/or second angular sector may have an angular span in the range of from 40 degrees to 85 degrees inclusive.

It may be that each cross-section spans a distance along the relevant blink axis (i.e. the first blink axis in the first angular sector, the second blink axis in the second angular sector) of at least 5% of the minimum width of the inner zone.

It may be that the cross-sections of the first angular sector extend transversely (e.g. perpendicular) to the cross-sections of the second angular sector.

The first angular sector may be located in and/or be the first quadrant. The second angular sector may be located in and/or be the second quadrant. The first blink axis and first reference axis may be the blink axis and reference axis of the first quadrant respectively. The second blink axis and the second reference axis may be the blink axis and reference axis of the second quadrant respectively.

In a third aspect of the disclosure there is provided a contact lens comprising a contact lens body. The contact lens body may have a convex anterior surface, a concave posterior surface, and optionally, a peripheral edge therebetween. The contact lens body has a thickness between the anterior surface and the posterior surface. The contact lens body may comprise a peripheral zone. The peripheral zone may be adjacent the peripheral edge. It may be that the thickness of the body in the peripheral zone tapers towards the peripheral edge. The contact lens body may comprise an inner zone, for example circumscribed by the peripheral zone. The contact lens body may comprise an optic zone, for example circumscribed by the inner zone. It may be that in a 90 degree sector of the inner zone and for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens;
(iii) the maximum thickness of the lens body at any given radial position lies within 5 degrees or 5% of the angle of the first blink axis to the vertical meridian whichever is lesser in absolute terms; and/or
(iv) a reference axis extends transversely to the blink axis, and along said reference axis on each side of the blink axis for a distance ending at the blink axis and being equal to at least 5% of the minimum width of the inner zone, the thickness of the lens body monotonically increases with distance along the reference axis towards the blink axis by at least 15 μm or 10% of the minimum thickness along said reference axis whichever is greater in absolute terms. The contact lens of the third aspect may have any of the features described with reference to any other aspect of the disclosure, and vice versa.

In a fourth aspect of the disclosure there is provided a contact lens comprising a contact lens body. The contact lens body may have a convex anterior surface, a concave posterior surface, and optionally a peripheral edge therebetween. The contact lens body has a thickness between the anterior surface and the posterior surface. The contact lens body may comprise a peripheral zone, for example adjacent the peripheral edge. It may be that the thickness of the body in the peripheral zone tapers towards the peripheral edge. The contact lens body may comprise an inner zone, for example circumscribed by the peripheral zone. The contact lens body may comprise an optic zone, for example circumscribed by the inner zone. It may be that in a 90 degree sector of the inner zone and for the majority of the minimum width of the inner zone:
(i) the thickness of the lens body increases monotonically with distance from the peripheral edge radially inwardly; and/or
(ii) the thickness of the lens body at any given radial position varies with angular position around the centre of the optic zone by at least 15 μm or 10% of the minimum thickness in the inner zone whichever is greater in absolute terms, thereby forming a ridge that extends radially across the majority of the minimum width of the inner zone. It may be that the ridge lies along a (first) blink axis. The contact lens of the third aspect may have any of the features described with reference to any other aspect of the disclosure, and vice versa.

In a fifth aspect of the disclosure there is provided a contact lens package assembly comprising a package, for example a blister package. The contact lens package assembly may contain a (unworn) contact lens in accordance with any other aspect of the disclosure and/or having the features described with reference to any other aspect of the disclosure, and vice versa. The contact lens may be sealed in a cavity of the package. For example, the package may comprise a base member defining a cavity, and a lid to seal the cavity. The cavity may also contain a contact lens packaging solution. The contact lens package may comprise a label indicating an cylinder power and/or an axis number of the lens. It may be that the thickness of the lens body in the inner zone is non axisymmetric so as to ballast the lens as specified by the axis number. It may be that the thickness of the lens body in the inner zone is non axisymmetric so as to ballast the lens to provide the cylinder power along an axis orientated relative to a vertical meridian as defined by the axis number. It may be that the contact lens is a toric lens. It may be that the lens body in the optic zone and inner zone is configured to provide a cylinder power along the axis orientated relative to the vertical meridian of the lens as defined by the axis number.

In a sixth aspect of the disclosure there is provided a method of stabilizing a contact lens on an eye. The contact lens may comprise a contact lens body having an anterior surface positioned adjacent the eye, a concave posterior surface on the opposite side of the lens body to the anterior surface, and optionally a peripheral edge therebetween. The contact lens has a thickness between the anterior surface and the posterior surface. The method may comprise, while the contact lens is on the eye, the interaction of the lens body and one or more eyelids of the eye generating a force that acts to maintain the lens in a predetermined orientation on the eye. It may be that in said predetermined orientation the contact lens body comprises one or more of a vertical meridian and a horizontal meridian; an optic zone positioned over the pupil of the eye; an inner zone circumscribing the optic zone; and a first quadrant defined between the horizontal and vertical meridians in a superior portion of the inner zone. It may be that in said first quadrant, for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens, said first blink axis being inclined at an angle (a) having a magnitude of 5 degrees or less to the direction of motion of an upper eyelid of the eye during closing and/or (b) having a magnitude in the range of from 5 degrees to 50 degrees inclusive from the vertical meridian; and/or
(iii) the maximum thickness of the lens body at any given radial position lies within 5 degrees or 5% of the angle of the first blink axis to the vertical meridian whichever is lesser in absolute terms. The contact lens may be a contact lens according to any other aspect of the disclosure and/or having the features described with reference to any other aspect of the disclosure, and vice versa.

Thus, the method may comprise dynamic stabilization of the lens due to the thickness profile of the lens.

The direction of motion of an upper eyelid of the eye during closing may be defined as the angle obtained by combining the horizontal and vertical displacement of a dot on the upper eyelid, said dot being visible when the eyelid is fully open and being aligned with a vertical line through the pupil when the eyelid is fully open.

In a seventh aspect of the disclosure there is provided a method of manufacturing a contact lens. The contact lens may be a contact lens according to any other aspect of the disclosure and/or having the features described with reference to any other aspect of the disclosure, and vice versa. The method of manufacturing a contact lens may comprise determining an optical lens design, and then determining a ballasted lens design based on the optical lens design, and then making a lens to said ballasted lens design.

The method of manufacturing a contact lens may comprise determining an optical lens design. Said optical lens design specifies the shape of the anterior surface, the posterior surface and/or the thickness of the lens body so as to provide a predetermined optical profile in an optic zone of the lens. The optical lens design may provide the predetermined optical profile but without any ballasting to maintain and/or orientate the lens to the predetermined orientation. It may be that, in the optical lens design, the anterior and posterior surface are axisymmetric across the majority of, for example the whole of, the anterior surface area of the lens outside of the optic zone. It may be that, in the optical lens design, the anterior and posterior surface are spherical across the majority of, for example the whole of, the anterior surface area of the lens outside of the optic zone. It may be that, in the optical lens design the posterior surface of the lens defines the base curvature of the lens.

The method of manufacturing a contact lens may comprise determining a ballasted lens design. The ballasted lens design may incorporate ballast into the optical lens design. Said ballasted lens design may differ from the optical lens design (only) in respect of the shape of the anterior and/or posterior surfaces in the region of the lens forming the inner zone in the ballasted lens design. It may be that, in said ballasted lens design, the shape of the anterior surface, the posterior surface and/or the thickness of the lens body in the inner zone is modified with respect to the optical lens design so as to ballast the lens to a predetermined orientation on the eye. It may be that, in said ballasted lens design, the shape of the anterior surface, the posterior surface and/or the thickness of the lens body in the inner zone is modified with respect to the optical lens design to provide the thickness profile described above in connection with any other aspect. It may be that, in the ballasted lens design, the posterior surface of the lens defines the base curvature of the lens and/or is unchanged from the optical lens design.

It may be that said ballasting thereby defines a superior edge and an inferior edge of the lens, with a vertical meridian being defined from the superior edge toward the inferior edge, and a horizontal meridian being defined perpendicular thereto. It may be that, in said ballasted lens design, in the superior portion of the inner zone, in a first quadrant defined between the horizontal and vertical meridians and for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens; and/or
(iii) the maximum thickness of the lens body at any given radial position lies on the first blink axis and/or within 5 degrees or 5% of the angle of the first blink axis to the vertical meridian whichever is lesser in absolute terms.

The method of manufacturing a contact lens may comprise manufacturing a contact lens to the ballasted lens design. Said contact lens may have any of the features described above with reference to any other aspect, and vice versa. Manufacturing a contact lens to a design may comprise manufacturing a contact lens having an anterior surface, posterior surface and/or thickness as specified in the ballasted lens design.

Manufacturing a contact lens to the ballasted lens design may comprising molding a lens to the design. For example, molding a lens by placing a lens forming material between a female mold member having a concave lens member forming surface, and a male mold member having a convex lens member forming surface, wherein the shape of the concave lens member forming surface and the convex lens member forming surface is configured so as to produce a contact lens body having the shape specified in the ballasted lens design.

Manufacturing a contact lens to the ballasted lens design may comprise shaping, for example lathing a lens to the design. For example, shaping the anterior and/or posterior surfaces of a lens body to the shape specified in the ballasted lens design.

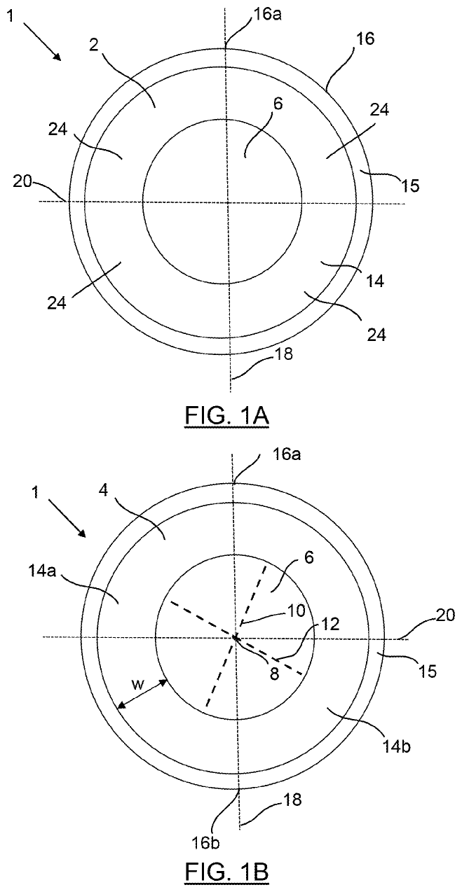

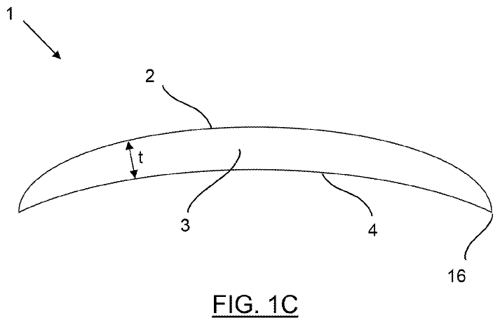

With reference to FIG. 1A, FIG. 1B and FIG. 1C there is shown a contact lens 1 in accordance with the present disclosure. A body 3 of the lens 1 comprises a front surface 2 and a rear surface 4 on the opposite side of the lens 1 to the front surface 2. The body 3 comprises a peripheral edge 16 between the rear surface 4 and the front surface 2. The lens 1 is substantially circular when viewed in plan and comprises an optic zone 6 which is centrally located on the lens. The rear surface 4 is a toric surface in the optic zone 6, and comprises a flat axis 10 and a steep axis 12 perpendicular to the flat axis 10. An optic zone centre 8 is located at the centre of the optic zone 6, at the intersection of the steep axis 12 and flat axis 10. In the example of FIG. 1A-C, the optic zone centre 8 is located at the geometric centre of the lens, but in other embodiments the optic zone and/or optic zone centre may be off centre with respect to the peripheral edge 16 of the lens. An inner zone 14 surrounds the optic zone 6 and extends from the outer edge of the optic zone 6 towards the peripheral edge 16 of the lens 1. A peripheral zone 15 surrounds the inner zone 14 and extends from the outer edge of the inner zone to the peripheral edge 16 of the lens. The inner zone 14 has a width ‘w’ which is the radial extent of the inner zone from the outer edge of the optic zone 6 to the inner edge of the peripheral zone 15. Where the optic zone 6, inner zone 14 and peripheral zone 15 are non-concentric and/or non-axisymmetric the width ‘w’ may vary, such that it has a minimum at some position around the circumference of the optic zone 6. This may be referred to as the minimum width of the inner zone. The lens has a thickness t which is defined as the distance between the front surface 2 and the rear surface 4 at any given location, when measured perpendicular to the rear surface 4. The thickness t of the lens varies with respect to the radial and circumferential position on the lens. The thickness t in the inner zone 14 is non-axisymmetric so as to ballast the lens such that a superior edge 16a of the lens is uppermost, and an inferior edge 16b of the lens is lowermost, when the lens 1 is in use on the eye, as will be described in more detail below. A vertical meridian 18 extends from the superior edge 16a to the inferior edge 16b. The flat axis 10 is inclined at an angle to a vertical meridian 18 of the lens 1, this being the “axis” of the lens. A horizontal meridian 20 of the lens is perpendicular to the vertical meridian 18, and intersects the vertical meridian 18 at the geometric centre of the lens, which in this case is also the optic zone centre 8. A superior portion 14a of the inner zone 14 is defined above the horizontal meridian 20, and an inferior portion 14b of the inner zone 14 is defined below the horizontal meridian 20. The inner zone 14 is divided by the vertical meridian 18 and horizontal meridian 20 into four quadrants 24.

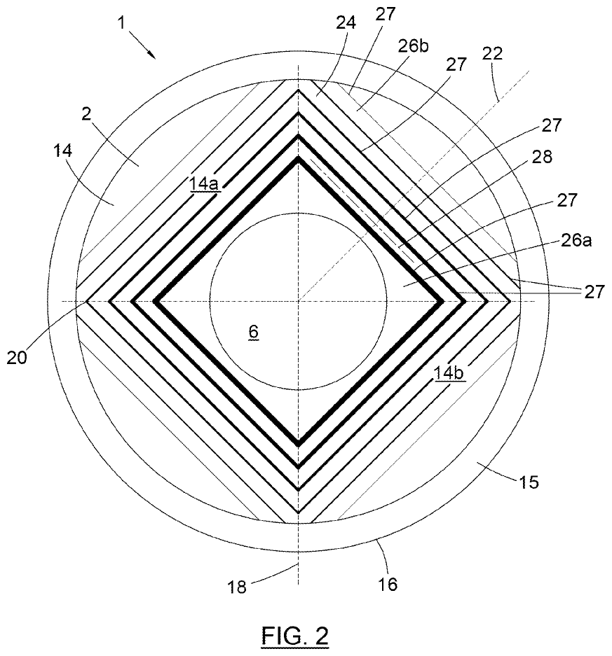

FIG. 2 is a plan view of the front surface 2 and shows details of the variation in the thickness t in the inner zone 14 of the lens 1 of FIGS. 1A-C in accordance with a first example embodiment of the disclosure. A notional blink radius 22 of the lens is inclined at an angle of 45 degrees to the vertical meridian 18 in the quadrant 24 on the upper-right in FIG. 2. In other embodiments, the blink radius may be at an angle of from 5 degrees to 50 degrees inclusive from the vertical meridian 18. A plurality of cross-sections 27 are located along the blink radius 22. Each cross-section 27 extends along a notional reference axis 28, the reference axis 28 being perpendicular to the blink radius 22. In each cross-section 27 the thickness t of the lens body is substantially constant (i.e. varies by not more than 15 μm or 10% of the minimum thickness of the lens body in the inner zone, whichever is greater in absolute terms). Thus, quadrant 24 comprises a plurality of constant-thickness cross-sections 27 in the inner zone 14. The cross-sections 27 are consecutive, and the thickness t of the regions increases with distance along the blink radius 22 from the edge of the inner zone 14 towards the optic zone centre 8. That is to say, the thickness of a region 26a closer to the optic zone 6 is greater than the thickness of a region 26b which is closest to the peripheral zone 15/peripheral edge 16. Each cross-section 27 extends perpendicular to the blink radius 22 and across the entire quadrant 24 (i.e. across an angular sector spanning 90 degrees or until it intersects with the outer edge of the inner zone 14). For the avoidance of doubt, FIG. 2 shows some of the cross-sections 27 as lines, with increased thickness denoted by increased width of the lines. For clarity, not all of the cross-sections 27 are shown in FIG. 2. In other embodiments, each cross-section 27 extends across an angular section of less than 90 degrees, for example of 50 degrees or less. The thickness profile of the inner zone 14 is symmetrical about the vertical and horizontal meridians 18, 20. In other embodiments, the thickness profile of the inner zone 14 is only symmetrical about the vertical meridian 18 (i.e. in the superior portion 14a of the inner zone), for example the front and/or rear surfaces may be spherical or near spherical in the inferior portion 14b of the inner zone 14. In yet further embodiments, the thickness profile in the inferior portion 14b of the inner zone 14 may comprise a series of constant-thickness cross-sections (similar to cross-sections 27 described above) that extend perpendicular to the vertical meridian 18.

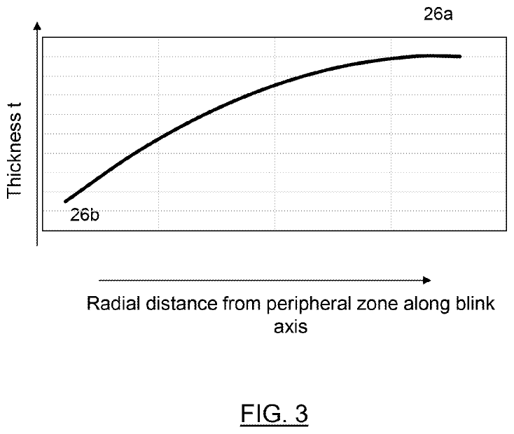

FIG. 3 shows a schematic plot of distance inward along the blink radius versus thickness t of the lens body in the inner zone for the lens of FIG. 2. The portion of the graph corresponding to region 26a (the region closest to the optic zone), and the region 26b (the region closest to the peripheral zone) are marked on the graph. The thickness monotonically increases in a smooth fashion from a minimum at region 26b to a maximum at region 26a. In other embodiments there may be a more stepwise transition between adjacent cross-sections.

Thus, contact lenses in accordance with the present example comprise a ballast mechanism in the form of a thickness profile that increases along an axis that is close to the direction of movement of the eyelid of a user during blinking. This may provide improved stabilisation of the lens on the eye. Additionally or alternatively, this may be more comfortable than prior art lenses. Additionally or alternatively, increasing thickness along the blink axis may facilitate incorporation of ballast into lower-powered lenses, because the thickness increases towards the centre of the lens and optic zone.

While lenses in accordance with the present example may be most comfortable when the blink axis of the lenses is aligned with the axis of movement of a particular user's eyelid it will be appreciated that, even when there is not precise alignment, such lenses may still offer improvements in comfort and/or stability over lenses in which, for example, thickness increases along the vertical meridian.

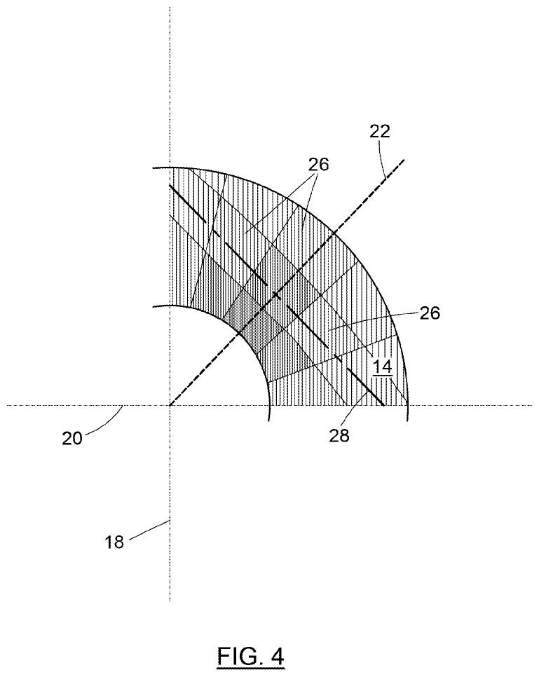

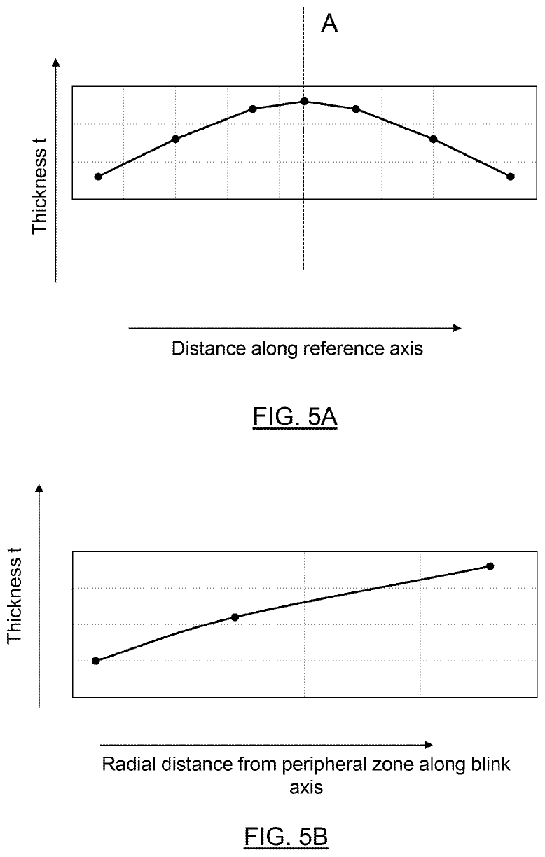

FIG. 4 is a plan view of part of the front surface and shows details of the variation in the thickness t in the upper-right quadrant of the inner zone 14 of the lens of FIGS. 1A to 1C in accordance with a second example embodiment of the disclosure. A notional blink radius 22 of the lens is inclined at an angle of 40 degrees to the vertical meridian 18. The horizontal meridian 20 is perpendicular to, and intersects with, the vertical meridian 18. In contrast to the second embodiment, the thickness t of the lens body is not constant along a reference axis 28, defined perpendicular to the blink radius 22. Instead, the thickness t increases towards the blink radius, such that the maximum thickness at any given radial position lies on the blink axis. The thickness t also increases with distance along the blink radius 22 from the edge of the inner zone 14 towards the optic zone centre. For clarity, in FIG. 4 the lens body 3 is shown with regions 26 of constant thickness (as indicated by the hatching) so the thickness t appears to change in a stepwise fashion, but as discussed below in FIGS. 5A and 5B the thickness t varies smoothly with radial distance and distance along the reference axis. Thus, it will be appreciated that in the lens of FIG. 4 the thickness varies to produce a ridge that extends radially across the width of the inner zone, along the blink axis. However, in other embodiments, the change in thickness t may be stepwise. Again, the thickness profile of the inner zone 14 is symmetrical about the vertical meridian 18. In some embodiments, the thickness profile of the inner zone 14 is also symmetrical about the horizontal meridian 20.

FIG. 5A shows a schematic plot of the variation of the thickness t of the lens body along the reference axis in the inner zone for the lens of FIG. 4. As shown in FIG. 5A, on each side of the blink axis (the blink axis is indicated by dashed line A in FIG. 5A) the thickness t increases monotonically along the reference axis, to reach a maximum at the blink axis. The graph would have a similar shape at any location along the blink radius in the inner zone as shown in FIG. 4.

FIG. 5B shows a schematic plot of distance inwardly along the blink radius versus thickness t of the lens body in the inner zone for the lens of FIG. 4. The thickness t increases smoothly from a minimum adjacent the peripheral zone to a maximum adjacent the optic zone.

As in the first example embodiment, contact lenses in accordance with the present example comprise a ballast mechanism in the form of a thickness profile that increases along an axis that is close to the direction of movement of the eyelid of a user during blinking. In contrast to the first example, the thickness is also increasing on both sides of the blink axis in a direction perpendicular to the blink axis, thereby forming a ridge along the blink axis. This may provide yet further increased stabilisation of the lens on the eye and/or be yet more comfortable for the user. Additionally or alternatively, this may allow for stabilisation with less lens material and thereby improved oxygen transmissibility.

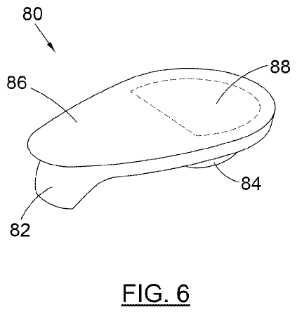

FIG. 6 shows a contact lens blister package 80. The blister package 80 comprises a base member 82 having a cavity 84 formed therein. The cavity 84 is sealed by a lid 86. A contact lens (not shown in FIG. 6), which may be a contact lens in accordance with any previous example embodiment, in sealed in the cavity 84 along with a volume of contact lens packaging solution (not shown in FIG. 6). This type of blister package will be well known to the skilled person, as will other similar types of blister package that are in widespread use today. The lid 86 comprises a printed region 88 (denoted by a dashed line in FIG. 6) which contains information including but not limited to the base curve of the lens, the diameter of the lens, the (spherical) power of the lens, the cylinder power of the lens and/or the axis of the lens. For example, in for a toric lens, the label may say “Cyl: −0.75×180” denoting a cylinder power of −0.75 being provided at the horizontal meridian. The contact lens is ballasted in order to provide the specified cylinder power at that axis when in use.

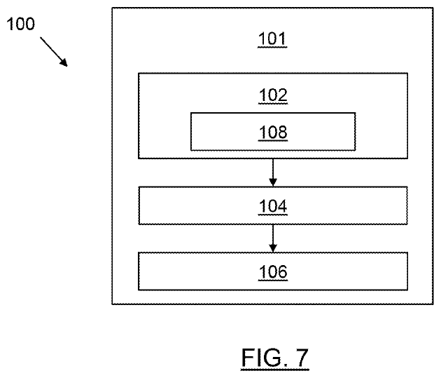

FIG. 7 shows a flow chart of an example method 100, in accordance with the present disclosure, of stabilizing a contact lens on an eye of a user. The contact lens may be a contact lens in accordance with any of the example embodiments described above. The method comprises, while the contact lens is on the eye 101, the interaction 102 of one or more eyelids of the eye and the contact lens body generating 104 a force that acts to maintain 106 the lens in a predetermined orientation on the eye. For a toric lens, said predetermined orientation may be an orientation in which a cylinder power is provided at a particular axis. For a cosmetic lens, said predetermined orientation may be an orientation in which the lens gives the desired appearance, e.g. a cat's eye with the long axis of the oval pupil vertical. Said interaction 102 of one or more eyelids of the eye and the contact lens body may comprise a closing upper eyelid of the eye moving 108 in a direction that is inclined at an angle having a magnitude of 5 degrees or less to a blink axis of the lens.

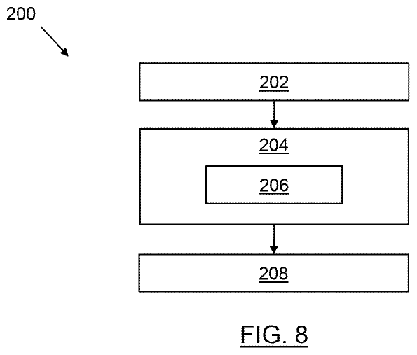

FIG. 8 shows a flow chart of an example method 200, in accordance with the present disclosure, of manufacturing a contact lens. The contact lens may be a contact lens in accordance with any of the example embodiments described above. The method may comprise determining 202 an optical lens design (i.e. a lens design that provides the desired optical power profile in the optic zone). The method may comprise determining 204 a ballasted lens design (i.e. a lens design that incorporates ballast into the inner zone of the optical lens design). Determining 204 a ballasted lens design comprises modifying 206 the thickness of the lens body in the inner zone to ballast the lens to a predetermined orientation, and results in a lens having a thickness profile in the inner zone in accordance with the present disclosure. The method then comprises manufacturing 208 a lens according to the ballasted lens design. Manufacturing 208 a lens according to the ballasted lens design may comprise molding and/or lathing a lens to provide a lens body having a shape as specified in the ballasted lens design.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. A contact lens comprising:
a contact lens body having a convex anterior surface, a concave posterior surface, and a peripheral edge therebetween,
the contact lens body having a thickness between the anterior surface and the posterior surface,
the contact lens body comprising:
a peripheral zone adjacent the peripheral edge, the thickness of the body in the peripheral zone tapering towards the peripheral edge;
an inner zone, circumscribed by the peripheral zone; and
an optic zone circumscribed by the inner zone;
the thickness of the lens body in the inner zone is non axisymmetric so as to ballast the lens and thereby define a superior edge and an inferior edge of the lens, with a vertical meridian being defined from the superior edge toward the inferior edge, and a horizontal meridian being defined perpendicular thereto;
the inner zone comprises a superior portion, being the portion of the inner zone above the horizontal meridian;
in the superior portion of the inner zone, in a first quadrant defined between the horizontal and vertical meridians, for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens; and
(iii) the maximum thickness of the lens body at any given radial position lies within 5 degrees or 5% of the angle of the first blink axis to the vertical meridian whichever is lesser in absolute terms; and
wherein the first blink axis is a straight line inclined at an angle from the vertical meridian, said angle having a magnitude in the range of from 5 degrees to 50 degrees inclusive.

2. The contact lens according to claim 1, wherein the first blink axis extends through the intersection of the vertical and horizontal meridians.

3. The contact lens according to claim 1, wherein a first reference axis extends transversely to the first blink axis, and along each first reference axis on each side of the first blink axis, the thickness of the lens body monotonically increases over a distance along the first reference axis towards the first blink axis, said distance ending at the blink axis and being equal to at least 5% of the minimum width of the inner zone.

4. The contact lens according to claim 1, wherein in said first quadrant, the inner zone comprises a series of consecutive cross-sections extending transversely to the first blink axis, wherein in each cross-section the lens body has a substantially uniform thickness not varying by more than 15 μm or 10% whichever is greater in absolute terms.

5. The contact lens according to claim 1, wherein in the superior portion of the inner zone, in a second, different, quadrant defined between the horizontal and vertical meridians and for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a second, different, blink axis of the lens; and
(iii) the maximum thickness of the lens body at any given radial position lies within 5 degrees or 5% of the angle of the first blink axis to the vertical meridian whichever is lesser in absolute terms.

6. The contact lens according to claim 1, wherein the thickness of the lens body in the first and second quadrants is symmetrical about the vertical meridian.

7. The contact lens according to claim 1, wherein in the inferior portion the inner zone comprises a series of consecutive inferior cross-sections extending transversely to the vertical meridian, each inferior cross-section spanning a distance along the vertical meridian of at least 5% of the minimum width of the inner zone, wherein in each inferior cross-section the lens body has a substantially uniform thickness not varying by more than 15 μm or 10% whichever is greater in absolute terms.

8. A contact lens comprising:
a contact lens body having a convex anterior surface, a concave posterior surface, and a peripheral edge therebetween,
the contact lens body having a thickness between the anterior surface and the posterior surface
the contact lens body comprising:
a peripheral zone adjacent the peripheral edge, the thickness of the body in the peripheral zone tapering towards the peripheral edge;
an inner zone, circumscribed by the peripheral zone; and
an optic zone circumscribed by the inner zone; and wherein
in a first angular sector of the inner zone spanning at least 10 degrees, the thickness of the lens body increases monotonically along a first blink axis of the lens, and the lens body comprises a series of consecutive cross-sections, each cross-section extending along a first reference axis, each first reference axis extending transversely to the first blink axis, each cross-section having a substantially uniform thickness not varying by more than 15 μm or 10% of the minimum thickness along said first reference axis whichever is greater in absolute terms; and
in a second, different, angular sector of the inner zone spanning at least 10 degrees, the thickness of the lens body increases monotonically along the length of a second, different, blink axis of the lens, and the lens body comprises a series of consecutive cross-sections, each cross-section extending along a second reference axis, each second reference axis extending transversely to the second blink axis, each cross-section having a substantially uniform thickness not varying by more than 15 μm or 10% of the minimum thickness along said reference axis whichever is greater in absolute terms.

9. The contact lens according to claim 8, wherein each of the first and second blink axes is a straight line inclined at an angle from a vertical meridian of the lens, said angle having a magnitude in the range of from 5 degrees to 50 degrees inclusive.

10. The contact lens according to claim 8, wherein each of the first and second angular sectors has an angular span in the range of from 40 degrees to 85 degrees inclusive.

11. A contact lens comprising:
a contact lens body having a convex anterior surface, a concave posterior surface, and a peripheral edge therebetween;
the contact lens body having a thickness between the anterior surface and the posterior surface;
the contact lens body comprising:
a peripheral zone adjacent the peripheral edge, the thickness of the body in the peripheral zone tapering towards the peripheral edge;
an inner zone, circumscribed by the peripheral zone; and
an optic zone circumscribed by the inner zone; and wherein in a 90 degree sector of the inner zone and for the majority of the minimum width of the inner zone:
(i) the thickness of the lens body at any given radial position varies with angular position around the centre of the optic zone by at least 15 μm or 10% of the minimum thickness in the inner zone whichever is greater in absolute terms;
(ii) the thickness of the lens body increases monotonically with distance from the peripheral edge inwardly along a first blink axis of the lens;
(iii) the maximum thickness of the lens body at any given radial position lies within 5 degrees or 5% of the angle of the first blink axis to the vertical meridian whichever is lesser in absolute terms; and
(iv) a reference axis extends transversely to the blink axis, and along said reference axis on each side of the blink axis for a distance ending at the blink axis and being equal to at least 5% of the minimum width of the inner zone, the thickness of the lens body monotonically increases with distance along the reference axis towards the blink axis by at least 15 μm or 10% of the minimum thickness along said reference axis whichever is greater in absolute terms.

12. The contact lens according to claim 1, wherein the thickness of the lens body in the inner zone increases along the or each blink axis from less than or equal to 100 μm to at least 300 μm.

13. The contact lens according to claim 1, wherein the contact lens is a toric lens and in the optic zone the lens body is configured to provide a cylinder power, for example wherein the anterior and/or posterior surfaces comprise a steep axis and a flat axis in the optic zone.

14. The contact lens according to claim 1, wherein in the inferior portion, for the majority of the minimum width of the inner zone, and over an angular sector of at least 45 degrees, the thickness of the lens body at any given radial position varies with angular position around the centre of the optic zone by less than 15 μm or 10% of the minimum thickness in the inner zone whichever is lesser in absolute terms.

15. A contact lens package assembly comprising a contact lens package and the contact lens in accordance with claim 1, said contact lens being sealed in a cavity of the contact lens package.

16-18. (canceled)
